(19) United States
(12) Patent Application Publication
(10) Pub. No.: US 2008/0182561 A1
(43) Pub. Date: Jul. 31, 2008

(54) SYSTEM FOR TRANSMITTING MEDIA CONTENTS TO MOBILE TERMINAL HAVING TWO-DIMENSIONAL CODE READER AND METHOD THEREOF

(76) Inventors: Sang Hun KIM, Goyang-si (KR); Jung Il PARK, Seongnam-si (KR)

Correspondence Address: HESLIN ROTHENBERG FARLEY & MESITI PC, 5 COLUMBIA CIRCLE, ALBANY, NY, 12203, US

(21) Appl. No.: 11/686,445

(22) Filed: Mar. 15, 2007

(30) Foreign Application Priority Data
Jan. 30, 2007 (KR) 10-2007-0009426

(51) Int. Cl. H04M 3/42

(52) U.S. Cl. 455/414.2; 455/406; 455/466

(57) ABSTRACT

A technique is provided for receiving contents using a mobile terminal provided with a digital camera and a technique of two-dimensional code. First, one or more two-dimensional code pattern areas are formed on a medium, and a user obtains image data by capturing a corresponding two-dimensional code pattern area using a digital camera of a mobile terminal, and obtains a unique identification code of a two-dimensional code pattern by reading the image data. If transmission of contents of the medium is requested by transmitting the unique identification code to a contents server through a mobile communication network, the contents server streams a moving image file of the corresponding medium to the mobile terminal in real-time.

### CROSS-REFERENCE TO RELATED APPLICATION

This application claims priority to Korean Patent Application No. 10-2007-0009426, filed Jan. 30, 2007, which is hereby incorporated herein by reference in its entirety.

### TECHNICAL FIELD

The present invention relates to a technique for receiving contents using a mobile terminal, and more specifically, to a method of transmitting media contents and a system therefor, in which a mobile station subscriber requests a server to transmit contents through a base station, and the server receives the request and transmits corresponding contents to a terminal of the mobile station subscriber.

### BACKGROUND OF THE INVENTION

With the increase of Internet users and the advancements in related techniques, diverse multimedia contents as well as simple text-oriented data are extensively processed on the web. Recently, contents having numerous data are exchanged and transacted through the Internet. From the viewpoint of information providers, a database for storing contents should be constructed, and an environment that allow users to easily access the database should be developed. From the viewpoint of information consumers, location of desired contents should be identified, and the consumers hope to obtain desired information in a convenient and speedy way.

As schematically shown in FIG. 1, requirements of such information providers and information consumers are fulfilled through the Internet 2. An information consumer can access a website of an information provider only by inputting a uniform resource locator (URL) or a by clicking a link where a URL is shown. A server 3 of the information provider can promptly transmit a large volume of data stored in a database 4 onto the web using a computer terminal 1. At this point, the consumer previously knows the URL of the information provider or obtains the location of the information provider through Internet surfing. For example, in order to obtain information on the movie “Love Story”, a user visits a portal site providing information thereof, and searches for “Love Story” or searches for a link to a webpage posting “Love Story” using a search engine.

However, such an Internet network has a problem in that it is lacking in instantaneousness and simultaneity. There is an enormous amount of information in the Internet, and websites providing information thereon are also innumerous. However, since contents desired by a user are generally very specific, it is inconvenient in that the user should go through a search procedure using the Internet to obtain the contents. That is, in order to search for the specific contents from the Internet, the user should access an Internet site where the contents are posted together with a large volume of other contents. Further, there is a problem in that the user himself or herself searches for the specific contents from a large scale database. For example, the user only desires one-minute moving image contents of a brief summary related to a certain subject (or an object), and thus the user does not need to spend a certain searching time and view entire one-hour moving image contents.

Further, the Internet is seriously lacking in mobility. Since the Internet requires the computer terminal 1 for accessing the Internet, there is a problem in that a user cannot easily use the Internet while moving.

A cellular network is an efficient system that can be used to transmit data to a moving terminal. By way of a base station, a use can transmit a simple text or receive multimedia contents using a mobile terminal. Owing to commercialization of high speed downlink packing access (HSDPA) of a 3.5 generation communication method and distribution of so-called HSDPA phones, a technical environment, through which multimedia contents can be received, has been constructed. In this network, it is important to construct a server that has a database for storing contents that are to be transmitted to a mobile station and to determine how specifically the mobile station requests the server to transmit corresponding contents. That is, the mobile station should be able to easily transfer location information of the contents that the user desires to the server side, and the server should previously construct a database for storing corresponding contents. However, it is very difficult for the mobile station to easily obtain location information of contents.

For example, before a user purchase a movie “Love Story” from a digital versatile disk (DVD) store, if the user desires to receive information that introduces the movie at the very spot, at least, the user should transmit a request signal specifying “Love Story” using a mobile terminal. However, the user cannot easily obtain minimum information required to transmit such a request signal. That is, specifying desired contents easily is troublesome in reality.

Further, since a mobile terminal does not have a keyboard or a mouse as does a notebook computer or a personal computer (PC), and a display thereof is a small size, it has a weakness in the user interface. Accordingly, it is not easy to search for information, or to construct and transmit a request signal. As a result, means or a method for simplifying the input process is becoming an essential element in the technical field of receiving and reproducing contents using a mobile terminal or in a business model based thereon.

That is, a method of using contents through a cellular network is advantageous in that a user can use the method while moving. However, it has a critical problem in that a consumer cannot easily access to the contents. Therefore, the consumer cannot easily identify where the contents are, and although the consumer knows the location of the contents, there is a limitation in using the contents in a speedy and convenient way. It is because that the consumer does not know the existence of the contents that he or she desires. Even though the consumer knows the existence, the user should search for the contents, but a user interface for performing the search is poor.

The inventor of the present invention files the present invention to solve all the aforementioned problems and propose an innovative business model that makes profits for both providers who provide contents and consumers who use the contents.

### SUMMARY OF THE INVENTION

Therefore, the present invention has been made in view of the above problems, and it is a first object of the present invention to provide a system for receiving media contents and a method thereof, in which regarding to a certain medium, if there is a medium, a user can immediately receive contents of a desired medium using the user's mobile terminal whenever and wherever. For this object, the relation between the medium and the contents should be emphasized together with and instantaneousness.

It is a second object of the invention to provide a contents providing environment through which a user can easily access to contents. Communications between consumers and providers have a conventional mobile client-server relationship in a fundamental packet transmission network. However, in the present invention, communications between media and a mobile terminal are particularly important. For this object, it should be emphasized that a consumer does not need to do a separate searching operation using a terminal in any circumstance.

It is a third object of the invention to have media be directly associated with contents so that a user can be further highly motivated to use the contents. For example, when purchasing a certain thing, a user desires to obtain information on the thing, such as detailed descriptions, reviews, notes, and the like. In the present invention, the thing is a medium, and the information on the thing is contents. When purchasing a DVD containing a movie, the DVD is the medium, and the trailer of the movie is contents. That is, since a medium is made to be directly associated with contents in the present invention, it should be emphasized that a user does not need to make a detour through another route or method, other than a corresponding medium, to obtain the contents (e.g., visiting an Internet website and extracting desired information, or the like).

On the other hand, other objects of the present invention unspecified in the specification will be additionally considered within a range that can be easily inferred from the detailed explanations described below and effects thereof.

Further, additional features and advantages are realized through the techniques of the present invention. Other embodiments and aspects of the invention are described in detail herein and are considered a part of the claimed invention.

### BRIEF DESCRIPTION OF THE DRAWINGS

The above and other objects, features and advantages of the present invention will be apparent from the following detailed descriptions of the preferred embodiments of the invention in conjunction with the accompanying drawings, in which:

FIG. 1 is a view schematically showing a conventional contents transmission system using the Internet;

FIG. 2 is a view schematically showing an example of the entire system configuration according to an aspect of the present invention;

FIG. 3 is a view schematically showing the configuration of a downstream system according to an aspect of the present invention;

FIG. 4 is a view schematically showing the relation between a medium and a mobile terminal according to an aspect of the present invention;

FIG. 5 is a view showing an example of a two-dimensional code; and

FIG. 6 is a view schematically showing the configuration of a code reader according to an aspect of the present invention.

FIG. 7 is a flowchart schematically showing the entire process according to an aspect of the present invention;

FIG. 8 is a flowchart showing step S20 of FIG. 7 in further detail;

FIG. 9 is a flowchart showing step S30 of FIG. 7 in further detail;

FIG. 10 is a view showing an embodiment of the present invention where a medium is a DVD containing a movie;

FIG. 11 is a view showing an embodiment of the present invention where a medium is a book;

FIG. 12 is a view showing a modified embodiment of FIG. 11; and

FIG. 13 is a view showing a detailed example of FIG. 12.

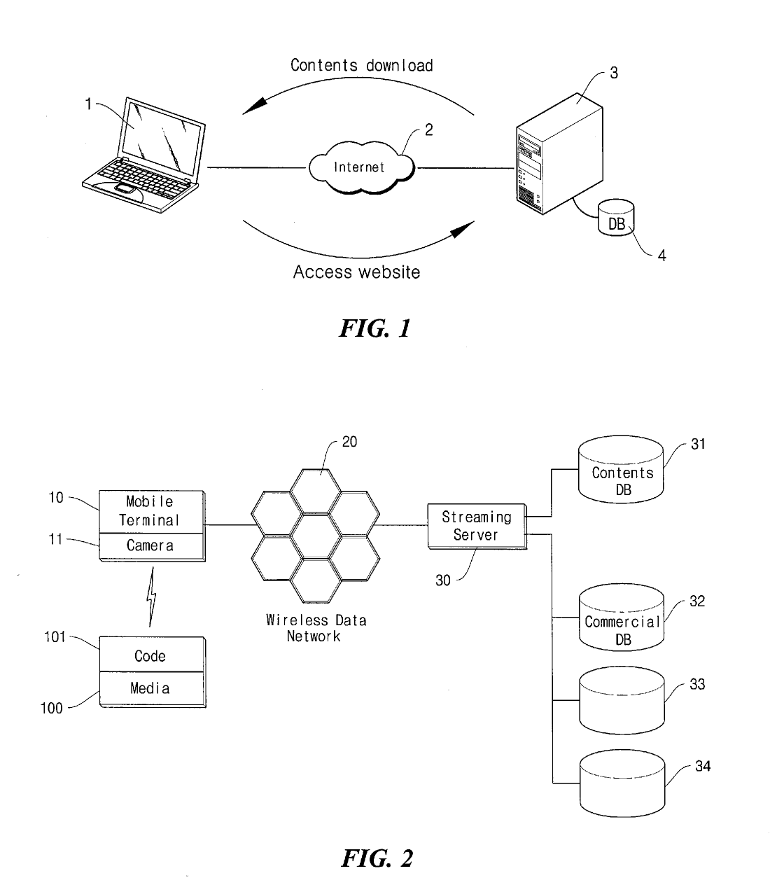

### BEST MODE FOR CARRYING OUT THE INVENTION

Embodiments of the invention will be hereafter described in detail, with reference to the accompanying drawings.

In the following description, the detailed description on known function and constructions unnecessarily obscuring the subject matter of the present invention will be avoided hereinafter.

FIG. 2 is an exemplary view schematically showing the configuration of the entire system according to one embodiment of the present invention. A two-dimensional code 101 pattern is attached to a medium 100. The two-dimensional code 101 is photographed by a digital camera 11 provided to a mobile terminal 10, and a read process is performed on the two-dimensional code. A request signal is transmitted through a base station (included in a transmission network 20) together with the read code. A streaming server 30 is provided with a contents database 31 for storing contents corresponding to the two-dimensional code 101, an advertisement database 32 for storing advertisement contents, a billing database 33 for processing bills, a log database 34 for storing log data, and the like. The streaming server extracts, from the database 31 and 32, media contents corresponding to an identification code received from the mobile terminal 10 and transmits the media contents to the mobile terminal 10. Through a display unit of the mobile terminal that has requested transmission of the contents, contents corresponding to the medium 100 are streamed in real-time. In the system of the present invention, a two-dimensional code is photographed using a digital camera embedded in the mobile cellular phone, and thus a user is close to the medium.

Generally, a user is close to a medium when the user desires to purchase the medium at the moment or to immediately obtain direct information on the medium. In the present invention, the user can immediately obtains information on the medium only by photographing the medium using a mobile cellular phone that the user has.

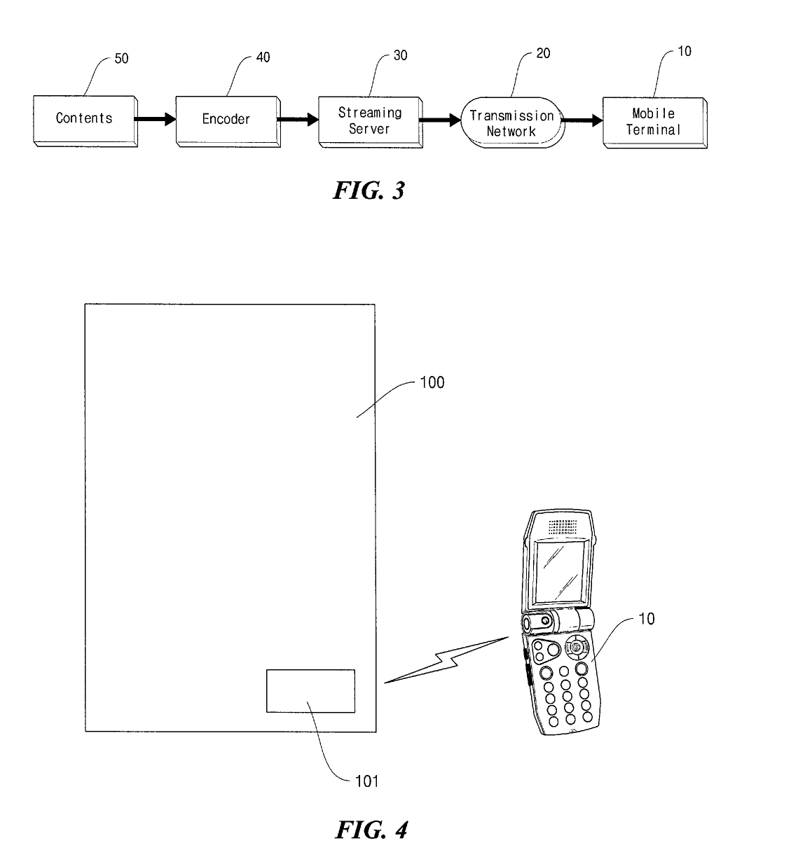

FIG. 3 schematically shows a downstream system of the present invention from the viewpoint of an operator of a server that provides contents of a medium. The server operator first manufactures contents 50 that contain information related to a medium. The contents are a media file, which should be encoded into a streaming file by an encoder 40 to be streamed to a mobile terminal. Particularly, the media file is converted into a streaming file having an appropriate bit rate, size, codec, file format, and the like, conforming to a mobile standard to be streamed in a mobile environment. The encoded streaming file is stored in a media folder of the streaming server 30, and a link to a corresponding medium is created so that a terminal can have an access to the streaming server and receive a streaming service. If a streaming request for corresponding contents is received from a mobile terminal, the streaming server 30 streams the corresponding contents to the mobile terminal 10 through a transmission network 20 such as a cellular network.

In the embodiment of FIG. 3, the contents 50 are assumed to be a media file, and the contents server 30 streams the contents. However, in another embodiment, contents can be a text, and in this case, the contents server 30 should be provided with a separate Short Message Service (SMS) server. At this time, transmission of the contents is accomplished in the form of an SMS, not a streaming.

FIG. 4 schematically shows the relation between the medium 100 and the mobile terminal 10, which also means the relation between the medium 100 and a user. The medium 100 has a variety of types and characteristics, such as a DVD containing a movie, DVD containing music, recoding medium containing computer programs, book, newspaper, magazine, poster, catalogue, manual, pamphlet, article, and the like. The user and the medium are in a very close distance to each other. It is important to comprehend the relation between the medium and the user to understand the technical art of the present invention.

| Media Type | Examples Of User's Desire | Provider's Desire |
|---|---|---|
| DVD containing | Desire to view trailers or the like | Desire to actively advertise |
| movie | | |
| DVD containing | Desire to listen to sample music | Desire to actively advertise |
| music | | |
| Book | Desire to view book information | Desire to actively advertise |
| DVD containing | Desire to view a portion of a game in | Desire to actively advertise |
| game software | advance | |
| Newspaper | Desire to view detailed contents or | Desire to |
| | advertisement contents contained in | combine newspapers and TV news |
| | a newspaper | enhance advertisement effects to |
| | | attract more customers |
| Magazine | Desire to view articles or | Desire to |
| | advertisement contents of a | combine articles and moving images |
| | magazine in further detail | enhance advertisement effects to |
| | | attract more customers |
| Poster | Desire to view contents of a poster in | Desire to actively advertise |
| | further detail | |
| Catalogue | Desire to view contents of a | Desire to actively advertise |
| | catalogue in further detail | |
| Manual | Desire to view a portion of a manual | Desire to reinforce manual functions |
| | in further detail | |
| Pamphlet | Desire to view contents of a | Desire to actively advertise |
| | pamphlet in further detail | |
| Article | Desire to have information on an | Desire to actively advertise good |
| | article in detail | points |

As shown in the table, users desire to obtain more information on media, and media providers desire to provide more contents related to the media. By doing so, transactions are activated, user's desires are fulfilled, and providers get more profits.

However, it is not easy to record additional information, especially information manufactured in the form of a moving image file, into the medium 100. For this purpose, separate means are needed. For this purpose, in the present invention, as shown in FIG. 4, an identification code having certain information is attached to the medium 100, and the mobile cellular phone 10 is provided with means for capturing and reading the identification code. In the present invention, even though the mobile cellular phone 10 reads the identification code of the medium 100, it is not that the additional information is immediately provided to the mobile cellular phone 10. In order to provide the additional information to the mobile cellular phone 10 only by reading the identification code, a wireless communication protocol between the mobile cellular phone 10 and the identification code should be defined, and the identification code should be provided with an additional antenna and memory. Further, since the mobile cellular phone 10 should also be provided with a short distance communication module, an effective business model cannot be established due to the difficulties in manufacturing the mobile cellular phone and increase of manufacturing costs. Especially, in such a method, there is no possibility of creating new profits at all.

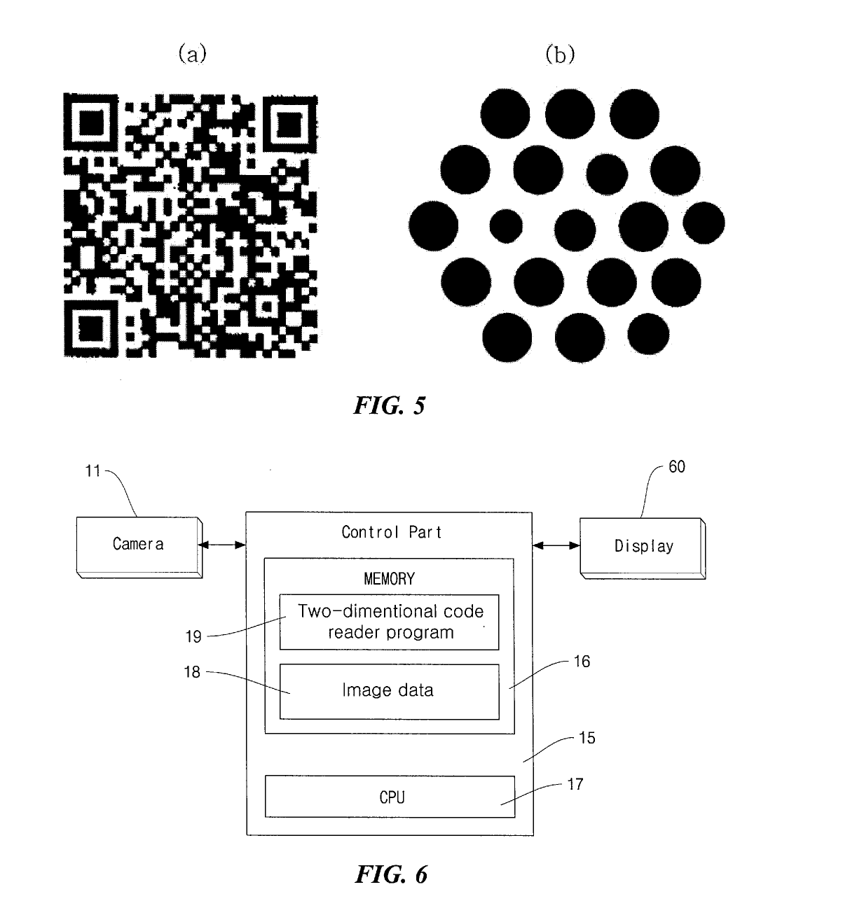

The identification code 101 used in the present invention is a two-dimensional code. FIG. 5 shows an example of the two-dimensional code. FIG. 5 (a) shows a matrix type two-dimensional code that is converted into a cell where binary coded data are arranged in two directions (vertical and horizontal directions). The display area of the matrix code is displayed in a dark (black) and bright (white) cell pattern (a rectangle on the whole), and the angles and size of the black-and-white cell pattern are read and decoded. FIG. 5 (b) shows a two-dimensional code having a plurality of symbols formed in a circular structure, i.e., a two-dimensional code where every symbol is placed within a two-dimensional lattice structure and the code value of the symbol is determined by the size of the circular symbol. A two-dimensional code pattern of the present invention stores a contents identification code previously given thereto, and it is noted that the contents identification code can have a variety of patterns and types. The contents identification code provided to a user by the medium, i.e., contents intended to be provided to the user through the contents identification code, comprises \textcircled{1} contents for providing detailed information on the medium to a user close to the medium and \textcircled{2} contents for providing advertisement contents to a user close to the medium by means of the medium.

The medium has one or more two-dimensional code pattern areas on which such a two-dimensional code pattern is printed. The two-dimensional code pattern area is manufactured by directly printing the two-dimensional code pattern on the medium. However, it is also manufactured by attaching a printed two-dimensional code pattern on a specific portion of the medium.

It is described that a contents identification code is attached on a medium in the form of a two-dimensional code pattern. Hereinafter, a method of reading the two-dimensional code pattern by the mobile terminal is described. FIG. 6 shows a code reader 15 comprising memory 16 and a central processing unit 17, a display 60 for displaying image information (a two-dimensional code), and a digital camera 11 for capturing image information. That is, FIG. 6 shows the code reader 15 among the configuration of a mobile cellular phone having a digital camera built therein. The memory 16 of the code reader 15 stores image data 18 inputted through the digital camera 11 and a two-dimensional code reader program 19 for performing a function of reading a two-dimensional code. The CPU 17 controls the two-dimensional code reader program 19 and performs two-dimensional code image processing according to the program. The two-dimensional code reader program 19 has a module for reading the captured image data of the two-dimensional code pattern and a module for recognizing the contents identification code of the corresponding image data.

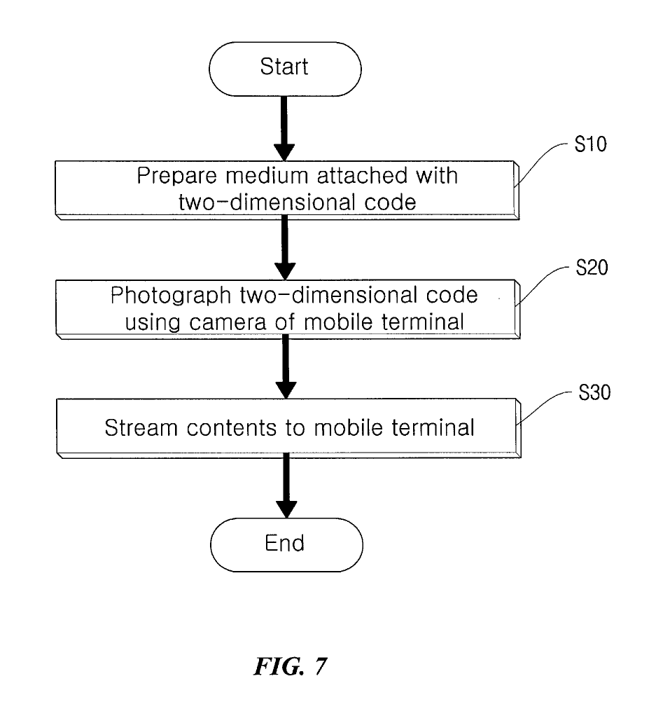

FIG. 7 schematically shows the entire process of a business model according to the present invention. That is, it is an example of the entire process configuration in the method of transmitting media contents to a mobile terminal having a two-dimensional code reader.

First, a medium is prepared S10. In step S10, the medium is prepared before a user recognizes the medium. One or more two-dimensional code patterns containing a contents identification code are attached or printed on a certain portion of the medium. The contents identification code is a code for identifying contents to be provided with, which are previously stored in the database of the contents server as contents related to the medium. If the medium is a movie DVD, it is sufficient to print a two-dimensional code pattern on a certain portion of the DVD case. If a plurality of advertisements are printed on a newspaper and the medium is for providing detailed contents of a corresponding advertisement, each of the advertisements has an independent identification code, and thus two-dimensional code patterns different from each other are formed. A medium of the present invention is previously provided with at least one or more two-dimensional code pattern areas. The medium previously prepared as such is placed at a specific offline space (e.g., a shop), and a user approaches to the medium to purchase the medium or to obtain information related to the medium. Therefore, the two-dimensional code pattern area printed on the medium is exposed to the user.

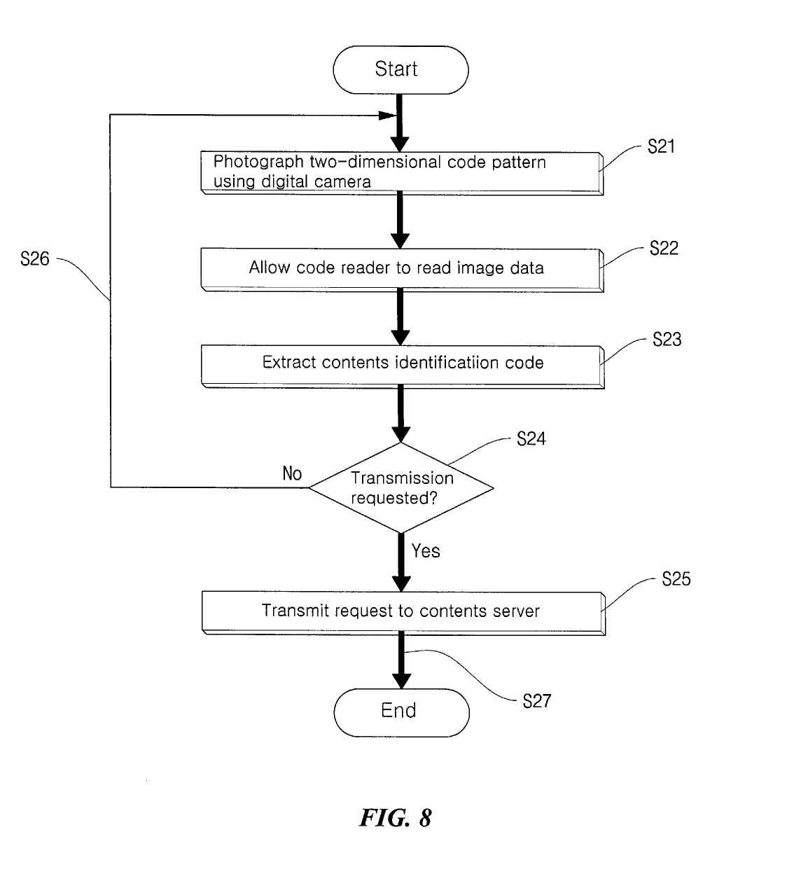

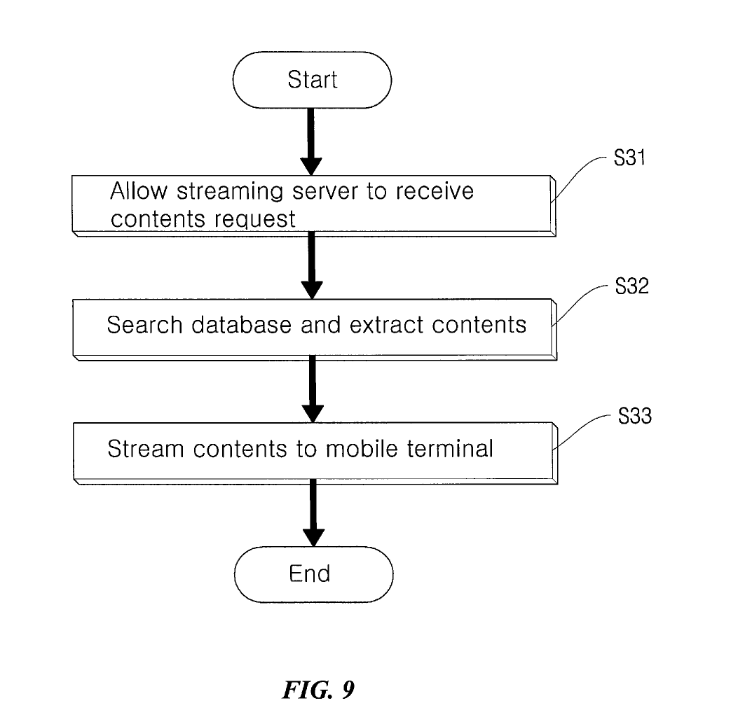

Next, the user's mobile terminal photographs the two-dimensional code pattern of the medium, processes the captured image, and transmits the identification code to the contents server through a mobile communication network S20. The contents server receiving the identification code extracts media contents corresponding to the identification code from the database that previously stores the media contents and transmits the media contents to the mobile terminal S30. Steps S20 and S30 will be described in detail referring to FIGS. 8 and 9.

FIG. 8 shows the process of reading a two-dimensional code of a medium using a mobile terminal in detail.

A user photographs a two-dimensional code pattern of a medium using a user's mobile terminal (e.g., a mobile cellular phone) S21. In the present invention, since image data of a two-dimensional code should be obtained using a mobile terminal, the mobile terminal should be provided with a digital camera.

A mobile terminal of the present invention should satisfy following conditions. First, it should be provided with a digital camera. Second, it should have a code reader. Third, it should be a terminal that can transmit and receive data through a mobile communication network (e.g., a cellular network).

If the digital camera captures the two-dimensional code pattern and obtains image data, the code reader embedded in the terminal reads corresponding image data through the previously stored two-dimensional code reader program S22. If reading the image data is failed due to a slanted angle, image distortion, focus, size, or the like while photographing the two-dimensional code pattern, obtaining the image data should be retried.

Next, the code reader reads the image data and extracts a contents identification code. Then, the terminal creates a request for transmitting data to the contents server through a mobile communication network S23. The request contains contents identification code data read by the code reader. It is determined whether the request is transmitted to the contents server S24, and if the user enters an ‘OK’ signal using an input key of the mobile terminal, a corresponding request signal is transmitted to the contents server S25. Through step S25, the user transmits identification code data of a two-dimensional code photographed using the mobile terminal camera, together with a signal that requests transmission of contents corresponding to the two-dimensional code, to the contents server.

Meanwhile, steps S26 and S27 are very useful in a certain embodiment. Step S26 means that contents transmission is not requested and image data of a two-dimensional code pattern of a corresponding medium can be stored in the memory of the terminal in the first place (in this case, the user can request transmission of the image data later). Step S27 is a step in which corresponding image data is stored in the memory after a request is transmitted to the contents server. The procedural locations of steps S26 and S27 can be exchanged with each other. However, the method of storing image data in the memory and using the image data later increases usability of the business model of the present invention. In this case, the subscriber of the mobile terminal can transmit the stored image data to another user.

FIG. 9 is a view showing the process of streaming contents to a mobile terminal in real-time by the streaming server.

The contents server receives a request from a mobile terminal S31. Communications between the contents server and the mobile terminal are accomplished through a mobile communication network such as a cellular network or the like, in which the mobile terminal is a mobile station subscriber of a mobile communication network, and the contents server communicates with the mobile terminal via a system of a mobile communication company.

Next, the contents server extracts corresponding contents from the previously constructed database and transmits the contents to the mobile terminal S32. That is, the contents server extracts contents corresponding to the identification code of the two-dimensional code of a medium using the data received from the mobile terminal and transmits the corresponding contents to the mobile terminal. The contents are previously stored in the database in the form of a video and/or audio media file and transmitted to the mobile terminal. The mobile terminal that receives the media file decompresses codec compression and plays back a corresponding file S33.

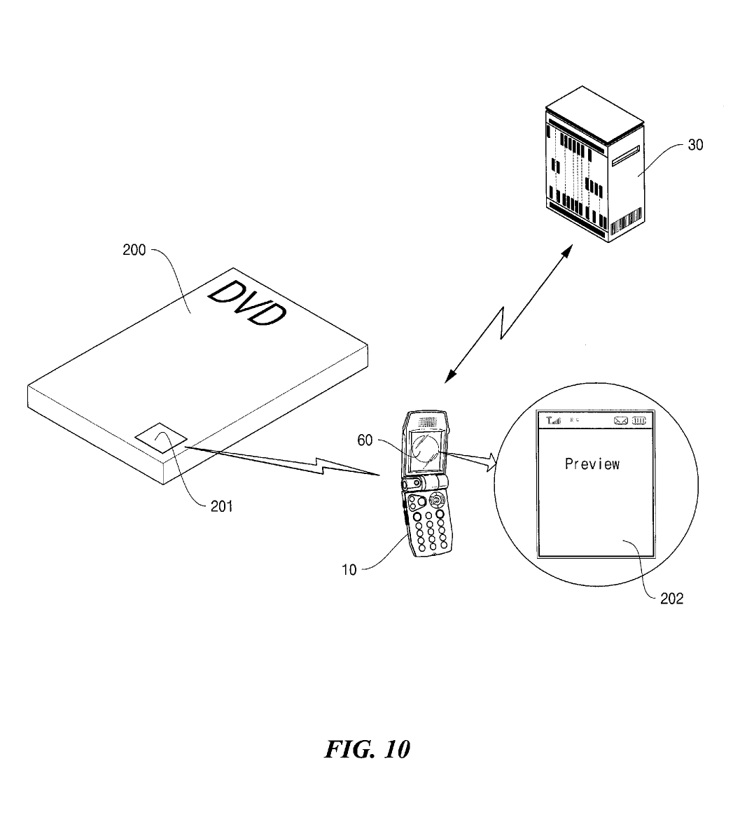

FIG. 10 is a view showing an embodiment where a medium is a DVD containing a movie according to the present invention.

A two-dimensional code pattern area 201 is formed on a specific portion of a DVD case 200. A user obtains image data of the two-dimensional code and reads the image data using the camera on the user's mobile cellular phone 10 to obtain a contents identification code. Then, the user transmits data of the contents identification code to the contents server to request streaming of a contents file. The contents server that receives the request extracts a corresponding contents file from the database and transmits the contents file. Next, if the terminal user who receives the contents file plays back the corresponding file, a trailer of a movie stored in a DVD is streamed on the display 60 of the terminal.

Up to date, a trailer of a movie could be obtained through a connection to a website using a computer or through broadcasting. The inventor of the present invention has already pointed out the limitation of a conventional method, lacking in mobility and instantaneousness. However, according to the present invention, since a user can view a trailer in real-time using his or her mobile cellular phone, it is greatly helpful in purchasing a DVD.

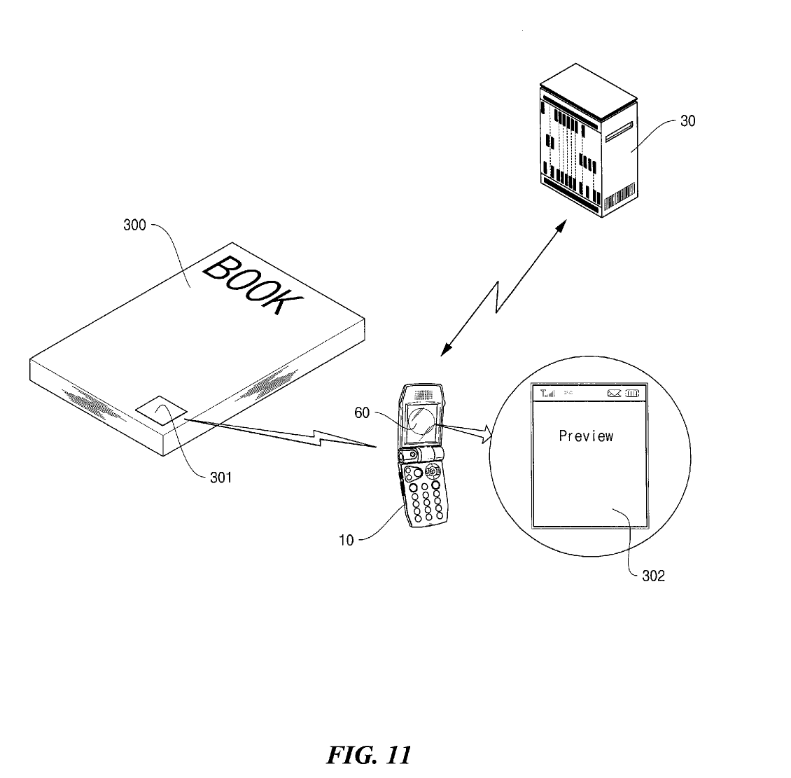

FIG. 11 is a view showing an embodiment where a medium is a book according to the present invention.

A two-dimensional code pattern area 301 is formed on a specific portion of a book cover 300. A user obtains image data of the two-dimensional code and reads the image data using the camera on the user's mobile cellular phone 10 to obtain a contents identification code. Then, the user transmits data of the contents identification code to the contents server to request streaming of a contents file. The contents server that receives the request searches for a corresponding contents file from the database and transmits the contents file. Next, if the terminal user who receives the contents file plays back the corresponding file, contents of the book are streamed on the display 60 of the terminal.

Up to date, additional information of a book could be obtained through a connection to a website or through broadcasting. The inventor of the present invention has already pointed out the limitation of a conventional method, lacking in mobility and instantaneousness. However, according to the present invention, since a user can obtain additional information on books in real-time through his or her mobile cellular phone, it will be very attractive marketing means when reader purchases books. For example, it is a business model in which an interview with a renowned writer about a book is previously video-taped, a media file thereof is manufactured and stored in the database of the contents server, and a corresponding media file is streamed to a user in real-time in the method of the present invention.

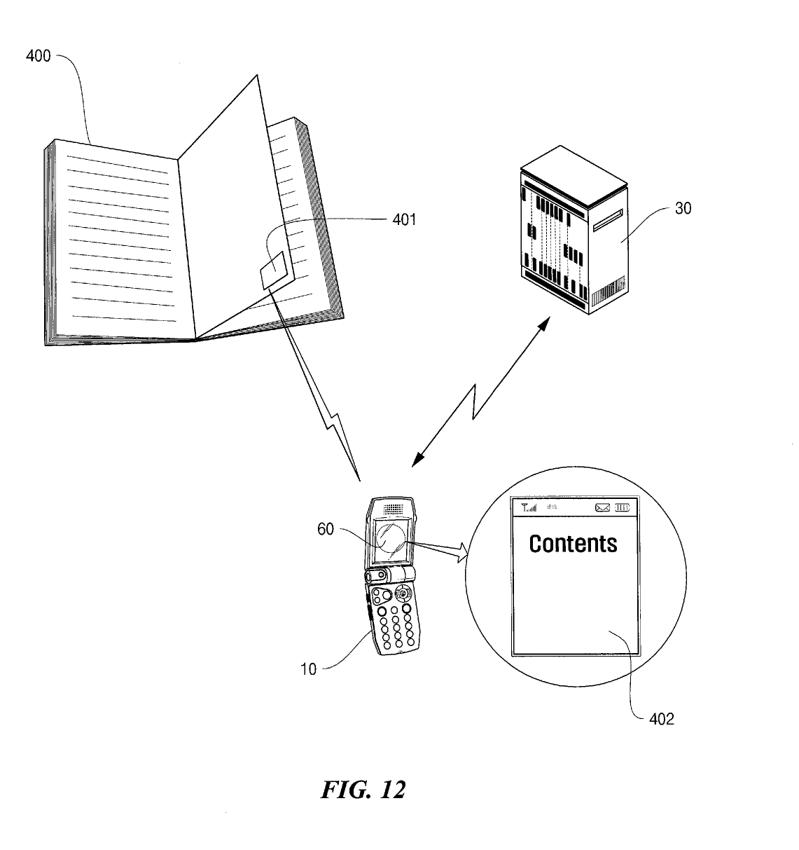

FIG. 12 is a view showing another embodiment where a medium is a book according to the present invention.

This embodiment is a modification of the embodiment of FIG. 11. In this case, a two-dimensional code pattern area 401 is formed at a specific portion of a specific page 400, not of a book cover. A user obtains image data of the two-dimensional code and reads the image data using the camera on the user's mobile cellular phone 10 to obtain a contents identification code. Then, the user transmits data of the contents identification code to the contents server to request streaming of a contents file. The contents server that receives the request extracts a corresponding contents file from the database and transmits the contents file. Next, if the terminal user who receives the contents file plays back the corresponding file, contents of the page of the book are streamed on the display 60 of the terminal.

This embodiment will present a medium of a new domain that combines papers with moving images and can be applied to a wide range of applications. For example, it is assumed that the book is a hotel guide book, a page 400 of the book contains information on the Plaza Hotel in New York City, and the contents identification code of the two-dimensional code pattern area 401 is for a media file of the New York Plaza Hotel. If a reader desires to view a moving image that introduces the New York Plaza Hotel while reading the book, the reader can immediately streams a corresponding media file in real-time using his or her mobile terminal.

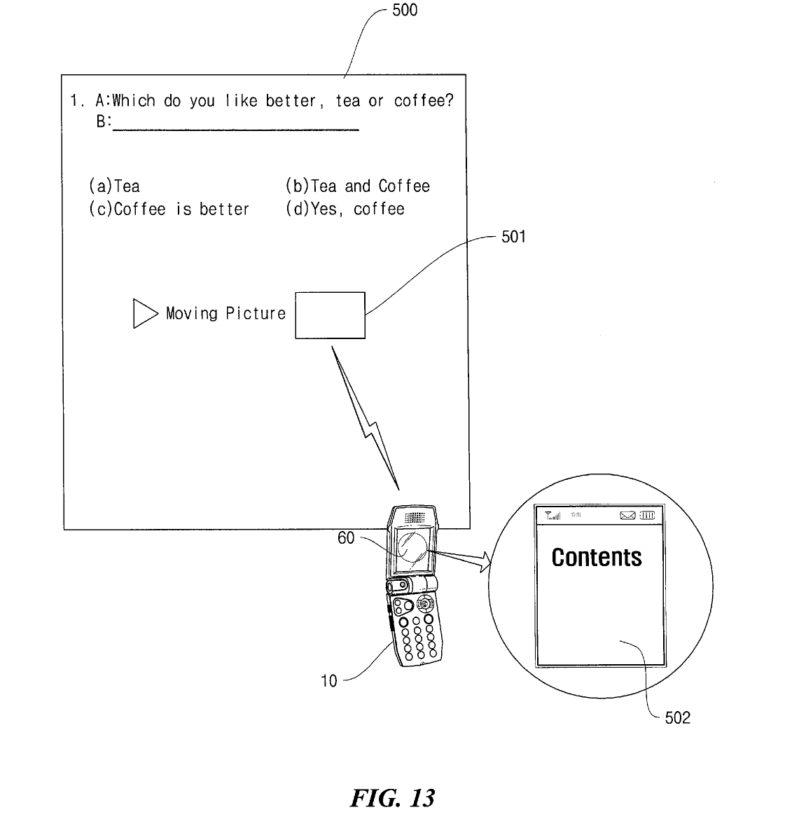

FIG. 13 is a view showing an example that applies FIG. 12 where the business model of the present invention is further specified through the example when a medium is an educational material.

A two-dimensional code pattern area 501 is formed on a specific portion of a page of an educational material 500. For example, a two-dimensional code pattern is formed under a question of an English test, i.e., a question of multiple-choice asking “Which do you like better, tea or coffee?” with four answer options of \textcircled{1} Tea, \textcircled{2} Tea and coffee, \textcircled{3} Coffee is better, and \textcircled{4} Yes, Coffee. A moving image file containing explanation of the question is already constructed in the database of the contents server. If the user desires to view the moving image file, the user obtains image data of the two-dimensional code and reads the image data using the camera on the user's mobile cellular phone 10 to obtain a contents identification code. Then, the user transmits data of the contents identification code to the contents server to request streaming of a contents file. The contents server that receives the request extracts a corresponding contents file from the database and transmits the contents file. Next, if the terminal user who receives the contents file plays back the corresponding file, contents of the corresponding question are streamed on the display 60 of the terminal.

A certain embodiment of the present invention is combined with a method of advertising. That is, media contents of the present invention contain advertisement contents. Then, the advertisement contents are previously stored in the database of the contents server, and a unique advertisement code is given thereto.

In correspondence to a contents identification code of a medium that is captured and transmitted through the user's mobile terminal, media contents are extracted from the database and streamed to the mobile terminal. At this point, the contents identification code is matched to the advertisement code according to predetermined advertisement rules, and advertisement contents corresponding to the advertisement code are extracted from the advertisement database and transmitted to the mobile terminal together with the media contents. That is, together with the media contents desired by a user, the advertisement contents are streamed to the user's mobile terminal. Since the advertisement rules are established such that the advertisement contents are directly associated with the requested media contents, advertisement effects of this business model will be tremendous.

In addition, the contents server records the number of streaming the advertisement contents and processes billing for customers based on the recorded number. At this point, since the contents server pays the bill of a mobile communication company for streaming the advertisement contents (customers will be charged in the end), the user is free of charge.

Meanwhile, the embodiments as specifically described above should not be interpreted to limit the scope for protection of the present invention. It should be also noted that obvious modifications or substitutions in the technical field to which the present invention pertains cannot limit the scope for protection of the present invention.

According to the present invention described above, it is advantageous in that if there is a medium, a mobile terminal user can be immediately streamed with contents of the medium in real-time using the user's mobile terminal whenever and wherever.

Further, according to the present invention, since a mobile terminal user only needs to approach the user's terminal to a corresponding medium and photograph the medium, it is advantageous in that the user does not need to do unnecessary activities, such as a separate searching operation or the like, in order to obtain additional contents of the medium.

Further, in the present invention, since a two-dimensional code pattern area formed on a medium is simply configured through an interface between the medium and the mobile terminal, additional hardware (a wireless antenna, wireless communication module, and the like) is not needed, and thus it is advantageous in that the system according to the present invention can be used economically and universally.

Further, in the present invention, it is advantageous in that a medium is highly associated with contents. That is, in the present invention, when a user most closely approaches to an interesting medium, i.e., when a desire for possessing information on the corresponding medium is most strong, contents related to the medium can be immediately provided, and thus desires of contents consumers can be fulfilled. Accordingly, probability of contents consumer's purchasing the medium can be increased, and thus contents providers and media providers (the contents providers and the media provider can be the same or different from each other) can make a large profit.

Further, since traffic of wireless packets is increased, the present invention will significantly contribute to creating profits of mobile communication companies. The present invention is a business model that provides useful means for a variety of marketing activities and advertisement activities and thus creates a great profit.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A system for transmitting media contents to a mobile terminal having a two-dimensional code reader, the system comprising:
a two-dimensional code pattern containing a contents identification code;
a medium having one or more two-dimensional code pattern areas where the two-dimensional code pattern is printed;
a mobile terminal for photographing the two-dimensional code pattern of the medium using a digital camera and reading a contents identification code using a code reader; and
a contents server provided with a database for storing media contents related to the medium, for receiving the contents identification code transmitted from the mobile terminal through a wireless communication network, extracting media contents corresponding to the contents identification code from the database, and transmitting the media contents to the mobile terminal.

2. The system according to claim 1, wherein the contents is a moving image file, and a corresponding moving image file is streamed to the mobile terminal.

3. The system according to claim 1, wherein the media contents includes advertisement contents, and the advertisement contents are combined with the contents related to the medium and transmitted to the mobile terminal.

4. The system according to claim 1, wherein the code reader is embedded in the mobile terminal, and a memory of the code reader stores image data of the two-dimensional code photographed by the digital camera and a two-dimensional code reader program for reading the image data.

5. The system according to claim 1, wherein the medium is any one selected from a DVD containing a movie, DVD containing music, recoding medium containing computer programs, book, newspaper, magazine, poster, catalogue, manual, pamphlet, and article.

6. The system according to claim 1, wherein the mobile terminal is a mobile cellular phone having the digital camera built therein.

7. A method of transmitting media contents to a mobile terminal having a two-dimensional code reader, the method comprising:
preparing a medium having one or more two-dimensional code patterns, each of which contains a contents identification code;
transmitting contents identification code data obtained by photographing the two-dimensional code pattern of the medium using a digital camera of the mobile terminal to a contents server through a mobile communication network; and
allowing the contents server that receives the contents identification code data to transmit media contents corresponding to the contents identification code to the mobile terminal.

8. The method according to claim 7, wherein the medium is any one selected from a DVD containing a movie, DVD containing music, recoding medium containing computer programs, book, newspaper, magazine, poster, catalogue, manual, pamphlet, and article.

9. The method according to claim 7, wherein the contents is a moving image file, and a corresponding moving image file is streamed to the mobile terminal.

10. The method according to claim 7, wherein the mobile terminal is a mobile cellular phone having the digital camera built therein.

11. The method according to claim 7, wherein the transmitting, by the mobile terminal, the contents identification code data to the contents server comprises:
obtaining image data by photographing the two-dimensional code pattern using the digital camera embedded in the mobile terminal;
allowing the code reader embedded in the mobile terminal to read the image data through a previously stored two-dimensional code reader program to thereby obtain the contents identification code data;
determining whether to transmit the contents identification code data to the contents server; and
transmitting a request for requesting transmission of contents corresponding to the contents identification code data to the contents server.

12. The method according to claim 7, wherein the media contents includes advertisement contents, and the method of allowing the contents server to transmit media contents further comprises the step of allowing the contents server to stream the media contents containing the advertisement contents to the mobile terminal.

13. The method according to claim 12, further comprising:
allowing the contents server to record the number of streaming the advertisement contents; and
allowing the contents server to perform billing based on the recorded number of streaming.
